(19) United States
(12) Patent Application Publication
(10) Pub. No.: US 2022/0318696 A1
(43) Pub. Date: Oct. 6, 2022

(54) TRANSPORT SYSTEM, SERVER APPARATUS, AND PROGRAM

(71) Applicant: HONDA MOTOR CO., LTD., Tokyo (JP)

(72) Inventor: Hiroshi MORIKAWA, Saitama (JP)

(21) Appl. No.: 17/692,174

(22) Filed: Mar. 11, 2022

(30) Foreign Application Priority Data
Mar. 31, 2021 (JP) 2021-059035

(51) Int. Cl. G06Q 10/06

(52) U.S. Cl. CPC G06Q 10/0631; G06Q 2240/00

(57) ABSTRACT

To provide a transport system, a server apparatus, and a program that make it possible to fill a parked vehicle with hydrogen. A transport system according to an embodiment includes a server apparatus and a transport apparatus. The transport apparatus transports a vehicle having a hydrogen tank based on an instruction given by the server apparatus. The server apparatus includes a processing unit. The processing unit receives an input of first information indicating that the vehicle needs to be filled with hydrogen. In a case in which the input of the first information has been received, the processing unit instructs the transport apparatus to transport the vehicle to a filling area for hydrogen filling and instructs the transport apparatus to transport the vehicle from the filling area to a parking area for vehicle parking.

This application is based on and claims the benefit of priority from Japanese Patent Application No. 2021-059035, filed on 31 Mar. 2021, the content of which is incorporated herein by reference.

### BACKGROUND OF THE INVENTION

### Field of the Invention

The present invention relates to a transport system, a server apparatus, and a program.

### Related Art

A known system transports a vehicle to a parking space. Some drivers, such as a driver of a vehicle equipped with a fuel cell, want to have their vehicles filled with hydrogen while the vehicles are parked.
Patent Document 1: Japanese Unexamined Patent Application, Publication No. 2020-138617

### SUMMARY OF THE INVENTION

An object of an embodiment of the present invention is to provide a transport system, a server apparatus, and a program that make it possible to fill a parked vehicle with hydrogen.

A transport system according to an embodiment of the present invention includes a server apparatus and a transport apparatus. The transport apparatus transports a vehicle having a hydrogen tank based on an instruction given by the server apparatus. The server apparatus includes a processing unit. The processing unit receives an input of first information indicating that the vehicle needs to be filled with hydrogen. In a case in which the input of the first information has been received, the processing unit instructs the transport apparatus to transport the vehicle to a filling area for hydrogen filling and instructs the transport apparatus to transport the vehicle from the filling area to a parking area for vehicle parking.

The present invention makes it possible to fill a parked vehicle with hydrogen.

### BRIEF DESCRIPTION OF THE DRAWINGS

FIG. 1 is a diagram illustrating an overview of an example of a parking system 1 according to an embodiment of the present invention;

FIG. 2 is a block diagram illustrating an exemplary configuration of main components of a server apparatus in FIG. 1;

FIG. 3 is a block diagram illustrating an exemplary configuration of main components of an entry apparatus in FIG. 1;

FIG. 4 is a block diagram illustrating an exemplary configuration of main components of an exit apparatus in FIG. 1;

FIG. 5 is a diagram showing two orthogonal views of an example of a transport robot in FIG. 1;

FIG. 6 is a block diagram illustrating an exemplary configuration of main components of the transport robot in FIG. 1;

FIG. 7 is a block diagram illustrating an exemplary configuration of main components of a filling apparatus in FIG. 1;

FIG. 8 is a block diagram illustrating an exemplary configuration of main components of a terminal apparatus in FIG. 1;

FIG. 9 is a flowchart showing exemplary processes to be performed by a processor in FIG. 3;

FIG. 10 is a flowchart showing exemplary processes to be performed by a processor in FIG. 2;

FIG. 11 is a flowchart showing exemplary processes to be performed by a processor in FIG. 6;

FIG. 12 is a flowchart showing exemplary processes to be performed by a processor in FIG. 7;

FIG. 13 is a flowchart showing exemplary processes to be performed by a processor in FIG. 8;

FIG. 14 is a flowchart showing exemplary processes to be performed by the processor in FIG. 2; and

FIG. 15 is a flowchart showing exemplary processes to be performed by a processor in FIG. 4.

### DETAILED DESCRIPTION OF THE INVENTION

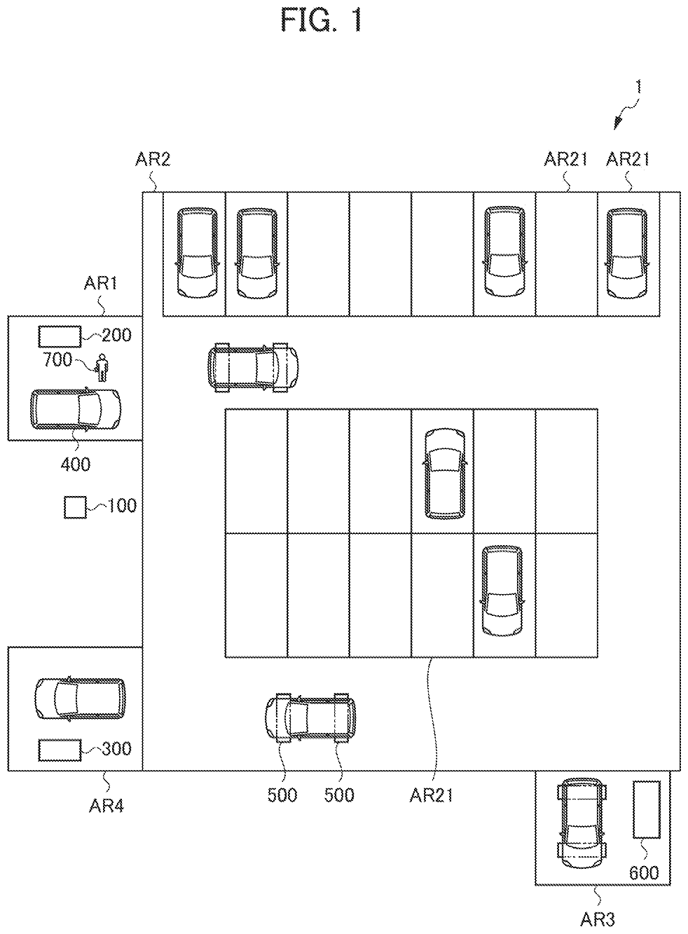

The following describes a parking system according to an embodiment of the present invention with reference to the accompanying drawings. Note that components shown in the drawings for use in explaining the embodiment are not necessarily to scale. In addition, some of the drawings for use in explaining the embodiment may show configurations in a simplified manner for the sake of explanation. The same reference numerals indicate the same or corresponding elements throughout the drawings and the present specification. FIG. 1 is a diagram illustrating an overview of an example of a parking system 1 according to the present embodiment. The parking system 1 automatically transports a vehicle 400 to a parking location. The parking system 1 also automatically transports the vehicle 400 to a location for hydrogen filling. The parking system 1 includes, for example, a server apparatus 100, an entry apparatus 200, an exit apparatus 300, vehicles 400, transport robots 500, a filling apparatus 600, and terminal apparatuses 700. The parking system 1 is, for example, used in a place that includes an entry area AR1, a parking area AR2, a filling area AR3, and an exit area AR4. The parking system 1 is an example of what is referred to as a transport system.

The server apparatus 100, the entry apparatus 200, the exit apparatus 300, the vehicles 400, the transport robots 500, the filling apparatus 600, and the terminal apparatuses 700 are connected to a network NW. The network NW is, for example, a communication network including the Internet, a local area network (LAN), and the like. The server apparatus 100, the entry apparatus 200, the exit apparatus 300, the vehicles 400, the transport robots 500, the filling apparatus 600, and the terminal apparatuses 700 each communicate with other apparatuses via the network NW. The server apparatus 100, the entry apparatus 200, the exit apparatus 300, the vehicles 400, the transport robots 500, the filling apparatus 600, and the terminal apparatuses 700 may each communicate with other apparatuses directly without using the network NW.

The entry area AR1 is an entrance to the parking area AP2 and the filling area AR3. The vehicles 400 are parked in the parking area AR2. The parking area AR2 includes, for example, a plurality of parking spaces AR21 each having a capacity for parking one vehicle 400. The vehicles 400 are filled with hydrogen in the filling area AR3. The exit area AR4 is an exit from the parking area AR2 and the filling area AR3.

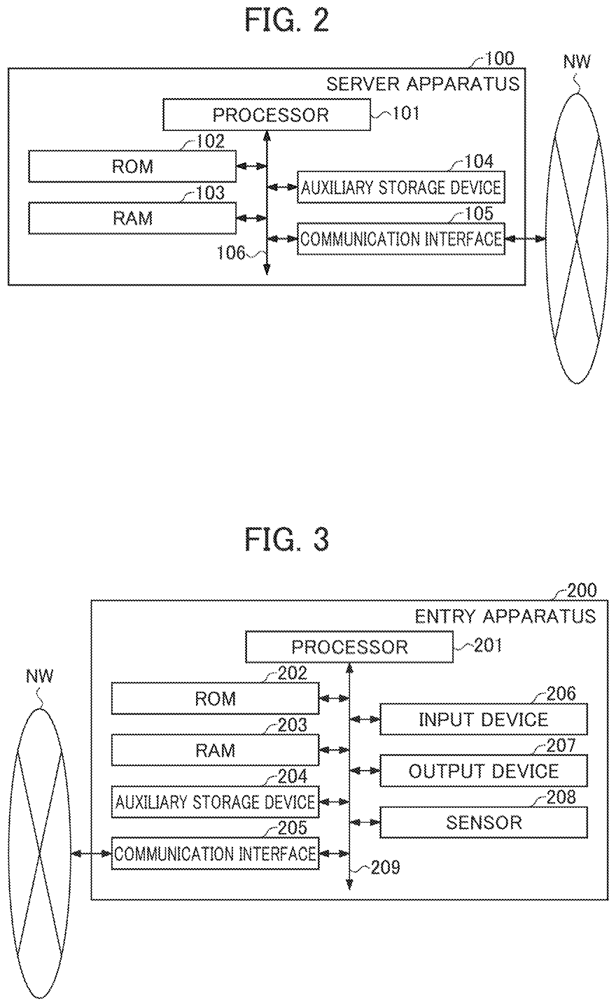

FIG. 2 is a block diagram illustrating an exemplary configuration of main components of the server apparatus 100. The server apparatus 100 performs, for example, overall control of the parking system 1 and storage of various data. The server apparatus 100 provides a parking service. The server apparatus 100 includes, for example, a processor 101, read-only memory (ROM) 102, random-access memory (RAM) 103, an auxiliary storage device 104, and a communication interface 105. These components are connected to one another by, for example, a bus 106.

The processor 101 is the processing center of a computer that performs processing, such as computation and control, necessary for operation of the server apparatus 100. The processor 101 performs various calculations and processes. The processor 101 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 is a combination of some of the devices mentioned above. The processor 101 may alternatively be a combination of any of the devices mentioned above and a hardware accelerator, for example. The processor 101 controls other components to implement various functions of the server apparatus 100 based on programs such as firmware, system software, and application software stored in the ROM 102 or the auxiliary storage device 104. The processor 101 also performs processes described below based on the programs. Some or all of the programs may be incorporated in a circuit of the processor 101.

The ROM 102 and the RAM 103 are main storage devices of the computer having the processor 101 as its processing center. The ROM 102 is non-volatile memory that is used exclusively for reading out data. The ROM 102 stores, for example, the firmware among the programs mentioned above. The ROM 102 also stores, for example, data to be used by the processor 101 in performing various processes. The RAM 103 is used for reading and writing data. The RAM 103 is used as, for example, a work area for storage of data to be temporarily used by the processor 101 in performing various processes. Typically, the RAM 103 is volatile memory.

The auxiliary storage device 104 is used by the computer having the processor 101 as its processing center. The auxiliary storage device 104 is, for example, electric erasable programmable read-only memory (EEPROM), a hard disk drive (HDD), or flash memory. The auxiliary storage device 104 stores, for example, the system software and the application software among the programs mentioned above. The auxiliary storage device 104 also stores information such as data to be used by the processor 101 in performing various processes, data generated through the processes performed by the processor 101, and various setting values. The ROM 102 and the auxiliary storage device 104 are each an example of what is referred to as a non-transitory computer readable medium.

The auxiliary storage device 104 also stores a parking database. The parking database contains information about vehicles 400 that are parked in the parking area AR2. The parking database contains schedule information indicating schedules including a scheduled clock time of the hydrogen filling for each vehicle 400. The schedule information indicates in which time slot and for which vehicle 400 the filling apparatus 600 is to be used for the hydrogen filling.

The communication interface 105 is used by the server apparatus 100 for the communication via, for example, the network NW.

The bus 106 includes, for example, a control bus, an address bus, and a data bus, and conveys signals to and from the components of the server apparatus 100.

FIG. 3 is a block diagram illustrating an exemplary configuration of main components of the entry apparatus 200. The entry apparatus 200 is, for example, installed in the entry area AR1. The entry apparatus 200 is, for example, used for reception to allow each vehicle 400 to enter the parking area AR2 and the filling area AR3. The entry apparatus 200 includes, for example, a processor 201, ROM 202, RAM 203, an auxiliary storage device 204, a communication interface 205, an input device 206, an output device 207, and a sensor 208. These components are connected to one another by, for example, a bus 209.

The processor 201 is the processing center of a computer that performs processing, such as computation and control, necessary for operation of the entry apparatus 200. The processor 201 performs various calculations and processes. The processor 201 is, for example, a CPU, an MPU, an SoC, a DSP, a GPU, an ASIC, a PLD, or an FPGA. Alternatively, the processor 201 is a combination of some of the devices mentioned above. The processor 201 may alternatively be a combination of any of the devices mentioned above and a hardware accelerator, for example. The processor 201 controls other components to implement various functions of the entry apparatus 200 based on programs such as firmware, system software, and application software stored in the ROM 202 or the auxiliary storage device 204. The processor 201 also performs processes described below based on the programs. Some or all of the programs may be incorporated in a circuit of the processor 201.

The ROM 202 and the RAM 203 are main storage devices of the computer having the processor 201 as its processing center. The ROM 202 is non-volatile memory that is used exclusively for reading out data. The ROM 202 stores, for example, the firmware among the programs mentioned above. The ROM 202 also stores, for example, data to be used by the processor 201 in performing various processes. The RAM 203 is used for reading and writing data. The RAM 203 is used as, for example, a work area for storage of data to be temporarily used by the processor 201 in performing various processes. Typically, the RAM 203 is volatile memory.

The auxiliary storage device 204 is used by the computer having the processor 201 as its processing center. The auxiliary storage device 204 is, for example, EEPROM, an HDD, or flash memory. The auxiliary storage device 204 stores, for example, the system software and the application software among the programs mentioned above. The auxiliary storage device 204 also stores information such as data to be used by the processor 201 in performing various processes, data generated through the processes performed by the processor 201, and various setting values.

The communication interface 205 is used by the entry apparatus 200 for the communication via, for example, the network NW.

The input device 206 receives operations by an operator of the entry apparatus 200. The input device 206 is, for example, a push button, a keypad, or a touchpad. The input device 206 may be a device for voice input.

The output device 207 notifies the operator of the entry apparatus 200 of various information. The output device 207 includes, for example, a speaker and a display such as a liquid crystal display or an organic electroluminescent (EL) display. The display displays a screen for notifying the operator of various information. The speaker outputs audio for notifying the operator of various information. Alternatively, a touch panel may be used as the input device 206 and the output device 207. Specifically, a display panel of the touch panel may be used as the output device 207, and a touch pad of the touch panel may be used as the input device 206.

The sensor 208 is used for reading various information from each vehicle 400.

The bus 209 includes, for example, a control bus, an address bus, and a data bus, and conveys signals to and from the components of the entry apparatus 200.

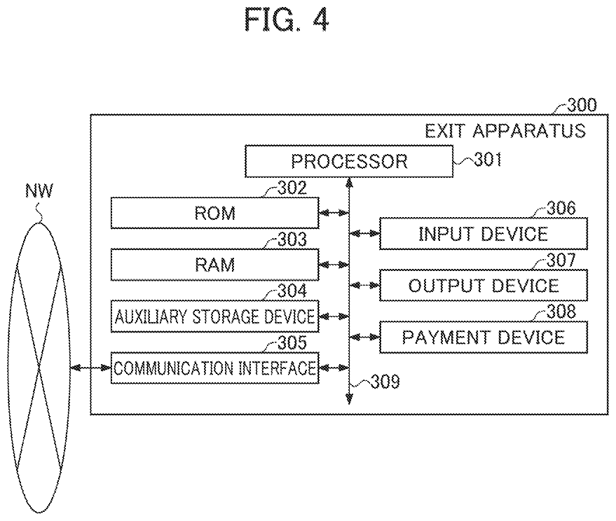

FIG. 4 is a block diagram illustrating an exemplary configuration of main components of the exit apparatus 300. The exit apparatus 300 is, for example, installed in the exit area AR4. The exit apparatus 300 includes, for example, a processor 301, ROM 302, RAM 303, an auxiliary storage device 304, a communication interface 305, an input device 306, an output device 307, and a payment device 308. These components are connected to one another by, for example, a bus 309.

The processor 301 is the processing center of a computer that performs processing, such as computation and control, necessary for operation of the exit apparatus 300. The processor 301 performs various calculations and processes. The processor 301 is, for example, a CPU, an MPU, an SoC, a DSP, a GPU, an ASIC, a PLD, or an FPGA. Alternatively, the processor 301 is a combination of some of the devices mentioned above. The processor 301 may alternatively be a combination of any of the devices mentioned above and a hardware accelerator, for example. The processor 301 controls other components to implement various functions of the exit apparatus 300 based on programs such as firmware, system software, and application software stored in the ROM 302 or the auxiliary storage device 304. The processor 301 also performs processes described below based on the programs. Some or all of the programs may be incorporated in a circuit of the processor 301.

The ROM 302 and the RAM 303 are main storage devices of the computer having the processor 301 as its processing center. The ROM 302 is non-volatile memory that is used exclusively for reading out data. The ROM 302 stores, for example, the firmware among the programs mentioned above. The ROM 302 also stores, for example, data to be used by the processor 301 in performing various processes. The RAM 303 is used for reading and writing data. The RAM 303 is used as, for example, a work area for storage of data to be temporarily used by the processor 301 in performing various processes. Typically, the RAM 303 is volatile memory.

The auxiliary storage device 304 is used by the computer having the processor 301 as its processing center. The auxiliary storage device 304 is, for example, EEPROM, an HDD, or flash memory. The auxiliary storage device 304 stores, for example, the system software and the application software among the programs mentioned above. The auxiliary storage device 304 also stores information such as data to be used by the processor 301 in performing various processes, data generated through the processes performed by the processor 301, and various setting values.

The communication interface 305 is used by the exit apparatus 300 for the communication via, for example, the network NW.

The input device 306 receives operations by an operator of the exit apparatus 300. The input device 306 is, for example, a push button, a keypad, or a touchpad. The input device 306 may be a device for voice input.

The output device 307 notifies the operator of the exit apparatus 300 of various information. The output device 307 includes, for example, a speaker and a display such as a liquid crystal display or an organic EL display.

Alternatively, a touch panel may be used as the input device 306 and the output device 307. Specifically, a display panel of the touch panel may be used as the output device 307, and a touch pad of the touch panel may be used as the input device 306.

The payment device 308 is used for payment of fees such as a usage fee for the parking in the parking area AR2 and a usage fee for the hydrogen filling in the filling area AR3. The payment device 308 includes, for example, a cash slot, a counting machine, and a change machine for cash payments. For another example, the payment device 308 includes a card reader and a barcode reader for cashless payments using credit cards and electronic money.

The bus 309 includes, for example, a control bus, an address bus, and a data bus, and conveys signals to and from the components of the exit apparatus 300.

Each vehicle 400 is, for example, a fuel cell vehicle (FCV) and is driven to run (travel) using, as motive power, electric power generated from a fuel cell. The vehicle 400 has a hydrogen tank that stores hydrogen for enabling the fuel cell to operate. The vehicle 400 also includes, for example, a control device for controlling the vehicle 400 and a communication device for communicating with other apparatuses.

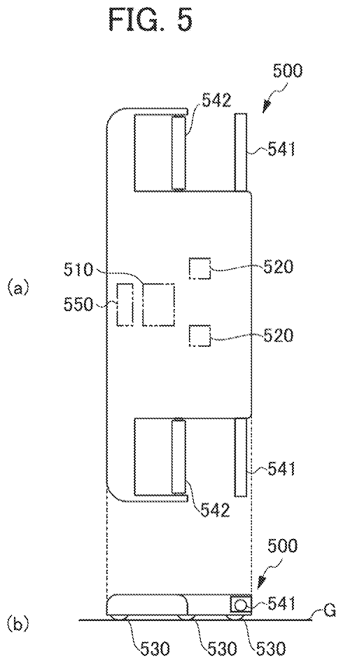

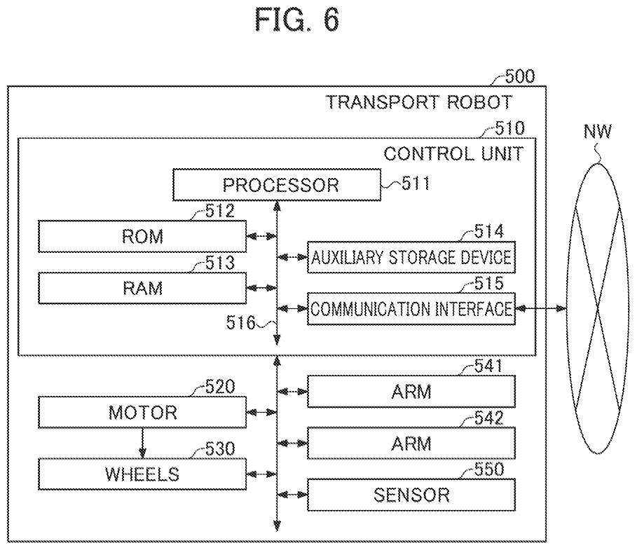

The following describes the transport robots 500 with reference to FIGS. 5 and 6. FIG. 5 is a diagram showing two orthogonal views of an example of the transport robots 500. The two orthogonal views in FIG. 5 are a top view (a) and a side view (b). FIG. 5 also shows ground G. FIG. 6 is a block diagram illustrating an exemplary configuration of main components of the transport robots 500. The transport robots 500 transport, for example, the vehicles 400. For example, two transport robots 500 form a pair to transport one vehicle 400. One of the two transport robots 500 lifts the front wheels of the vehicle 400, and the other transport robot 500 lifts the rear wheels of the vehicle 400. The pair of transport robots 500 travels while keeping this state, thereby transporting the vehicle 400. Each of the transport robots 500 includes, for example, a control unit 510, a motor 520, wheels 530, arms 541, arms 542, and a sensor 550. The transport robots 500 are an example of what is referred to as a transport apparatus.

The control unit 510 is a computer that performs processing, such as computation and control, necessary for operation of the transport robot 500. The control unit 510 includes, for example, a processor 511, ROM 512, RAM 513, an auxiliary storage device 514, and a communication interface 515. These components are connected to one another by, for example, a bus 516.

The processor 511 is the processing center of a computer that performs processing, such as computation and control, necessary for operation of the control unit 510. The processor 511 performs various calculations and processes. The processor 511 is, for example, a CPU, an MPU, an SoC, a DSP, a GPU, an ASIC, a PLD, or an FPGA. Alternatively, the processor 511 is a combination of some of the devices mentioned above. The processor 511 may alternatively be a combination of any of the devices mentioned above and a hardware accelerator, for example. The processor 511 controls other components to implement various functions of the control unit 510 based on programs such as firmware, system software, and application software stored in the ROM 512 or the auxiliary storage device 514. The processor 511 also performs processes described below based on the programs. Some or all of the programs may be incorporated in a circuit of the processor 511.

The ROM 512 and the RAM 513 are main storage devices of the computer having the processor 511 as its processing center. The ROM 512 is non-volatile memory that is used exclusively for reading out data. The ROM 512 stores, for example, the firmware among the programs mentioned above. The ROM 512 also stores, for example, data to be used by the processor 511 in performing various processes. The RAM 51:3 is used for reading and writing data. The RAM 513 is used as, for example, a work area for storage of data to be temporarily used by the processor 511 in performing various processes. Typically, the RAM 513 is volatile memory.

The auxiliary storage device 514 is used by the computer having the processor 511 as its processing center. The auxiliary storage device 514 is, for example, EEPROM, an HDD, or flash memory. The auxiliary storage device 514 stores, for example, the system software and the application software among the programs mentioned above. The auxiliary storage device 514 also stores information such as data to be used by the processor 511 in performing various processes, data generated through the processes performed by the processor 511, and various setting values.

The communication interface 515 is used by the transport robot 500 for the communication via, for example, the network NW.

The bus 516 includes, for example, a control bus, an address bus, and a data bus, and conveys signals to and from the components of the control unit 510.

The motor 520 drives components of the transport robot 500, such as the wheels 530, the arms 541, and the arms 542. The motor 520 may be a single motor or may be a motor group including a plurality of motors. Each transport robot 500 may include only one motor 520 or may include a plurality of motors 520. The wheels 530 are used for the transport robot 500 to travel.

The arms 541 are retractable to be contained inside the transport robot 500 when not in use. The arms 541 and 542 rotate to hold therebetween and lift the wheels of the vehicle 400.

The sensor 550 is, for example, used for measuring surroundings while the transport robot 500 is traveling. The sensor 550 is also used for identifying each vehicle 400 and other objects.

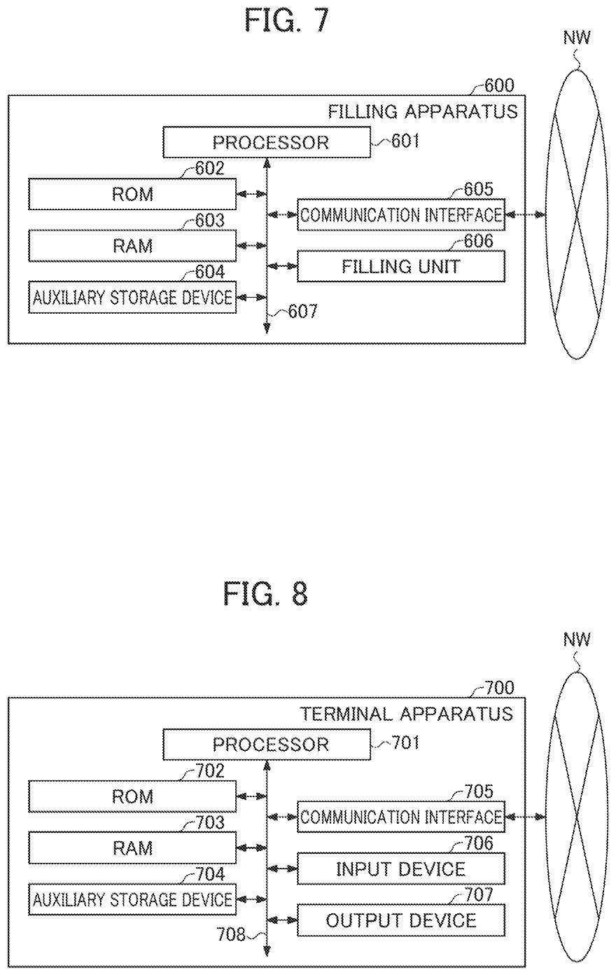

FIG. 7 is a block diagram illustrating an exemplary configuration of main components of the filling apparatus. The filling apparatus 600 fills a hydrogen tank of, for example, a vehicle 400 with hydrogen. The filling apparatus 600 includes, for example, a processor 601, ROM 602, RAM 603, an auxiliary storage device 604, a communication interface 605, and a filling unit 606. These components are connected to one another by, for example, a bus 607.

The processor 601 is the processing center of a computer that performs processing, such as computation and control, necessary for operation of the filling apparatus 600. The processor 601 performs various calculations and processes. The processor 601 is, for example, a CPU, an MPU, an SoC, a DSP, a GPU, an ASIC, a PLD, or an FPGA. Alternatively, the processor 601 is a combination of some of the devices mentioned above. The processor 601 may alternatively be a combination of any of the devices mentioned above and a hardware accelerator, for example. The processor 601 controls other components to implement various functions of the filling apparatus 600 based on programs such as firmware, system software, and application software stored in the ROM 602 or the auxiliary storage device 604. The processor 601 also performs processes described below based on the programs. Some or all of the programs may be incorporated in a circuit of the processor 601.

The ROM 602 and the RAM 603 are main storage devices of the computer having the processor 601 as its processing center. The ROM 602 is non-volatile memory that is used exclusively for reading out data. The ROM 602 stores, for example, the firmware among the programs mentioned above. The ROM 602 also stores, for example, data to be used by the processor 601 in performing various processes. The RAM 603 is used for reading and writing data. The RAM 603 is used as, for example, a work area for storage of data to be temporarily used by the processor 601 in performing various processes. Typically, the RAM 603 is volatile memory.

The auxiliary storage device 604 is used by the computer having the processor 601 as its processing center. The auxiliary storage device 604 is, for example, EEPROM, an HDD, or flash memory. The auxiliary storage device 604 stores, for example, the system software and the application software among the programs mentioned above. The auxiliary storage device 604 also stores information such as data to be used by the processor 601 in performing various processes, data generated through the processes performed by the processor 601, and various setting values.

The communication interface 605 is used by the filling apparatus 600 for the communication via, for example, the network NW.

The filling unit 606 fills a hydrogen tank of, for example, a vehicle 400 with hydrogen.

The bus 607 includes, for example, a control bus, an address bus, and a data bus, and conveys signals to and from the components of the filling apparatus 600.

FIG. 8 is a block diagram illustrating an exemplary configuration of main components of the terminal apparatuses 700. Each terminal apparatus 700 is, for example, a cell phone such as a smart phone, a tablet terminal, or a notebook personal computer (PC). The terminal apparatus 700 is carried by a person who rides a vehicle 400 such as the driver of the vehicle 400. The terminal apparatus 700 includes, for example, a processor 701, ROM 702, RAM 703, an auxiliary storage device 704, a communication interface 705, an input device 706, and an output device 707. These components are connected to one another by, for example, a bus 708.

The processor 701 is the processing center of a computer that performs processing, such as computation and control, necessary for operation of the terminal apparatus 700. The processor 701 performs various calculations and processes. The processor 701 is, for example, a CPU, an MPU, an SoC, a DSP, a GPU, an ASIC, a PLU, or an FPGA. Alternatively, the processor 701 is a combination of some of the devices mentioned above. The processor 701 may alternatively be a combination of any of the devices mentioned above and a hardware accelerator, for example. The processor 701 controls other components to implement various functions of the terminal apparatus 700 based on programs such as firmware, system software, and application software stored in the ROM 702 or the auxiliary storage device 704. The processor 701 also performs processes described below based on the programs. Some or all of the programs may be incorporated in a circuit of the processor 701.

The ROM 702 and the RAM 703 are main storage devices of the computer having the processor 701 as its processing center. The ROM 702 is non-volatile memory that is used exclusively for reading out data. The ROM 702 stores, for example, the firmware among the programs mentioned above. The ROM 702 also stores, for example, data to be used by the processor 701 in performing various processes. The RAM 703 is used for reading and writing data. The RAM 703 is used as, for example, a work area for storage of data to be temporarily used by the processor 701 in performing various processes. Typically, the RAM 703 is volatile memory.

The auxiliary storage device 704 is used by the computer having the processor 701 as its processing center. The auxiliary storage device 704 is, for example, EEPROM, an HDD, or flash memory. The auxiliary storage device 704 stores, for example, the system software and the application software among the programs mentioned above. The auxiliary storage device 704 also stores information such as data to be used by the processor 701 in performing various processes, data generated through the processes performed by the processor 701, and various setting values.

The communication interface 705 is used by the terminal apparatus 700 for the communication via, for example, the network NW.

The input device 706 receives operations by an operator of the terminal apparatus 700. The input device 706 is, for example, a keyboard, a keypad, a touchpad, a mouse, or a controller. The input device 706 may be a device for voice input.

The output device 707 notifies the operator of the terminal apparatus 700 of various information. The output device 707 includes, for example, a speaker and a display such as a liquid crystal display or an organic EL display. Alternatively, a touch panel may be used as the input device 706 and the output device 707. Specifically, a display panel of the touch panel may be used as the output device 707, and a touch pad of the touch panel may be used as the input device 706.

The bus 708 includes, for example, a control bus, an address bus, and a data bus, and conveys signals to and from the components of the terminal apparatus 700.

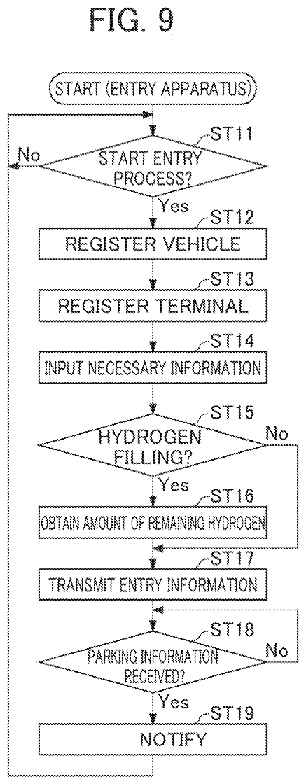

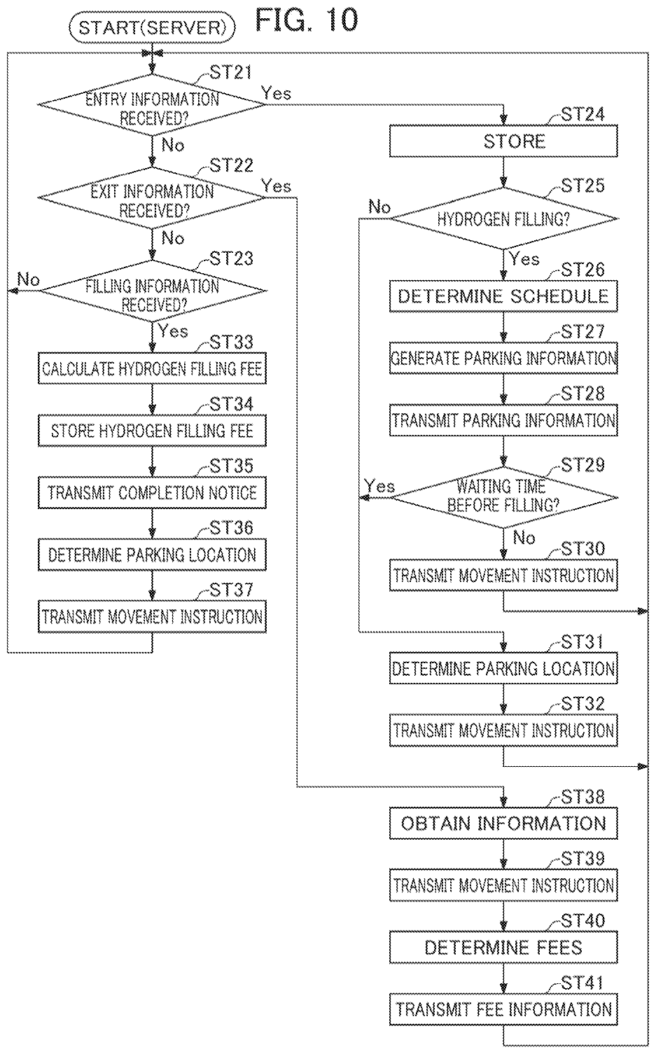

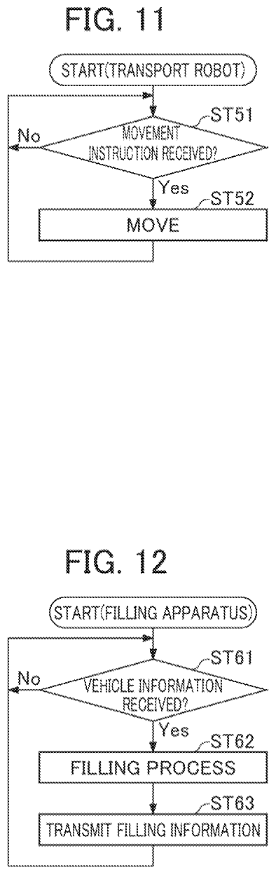

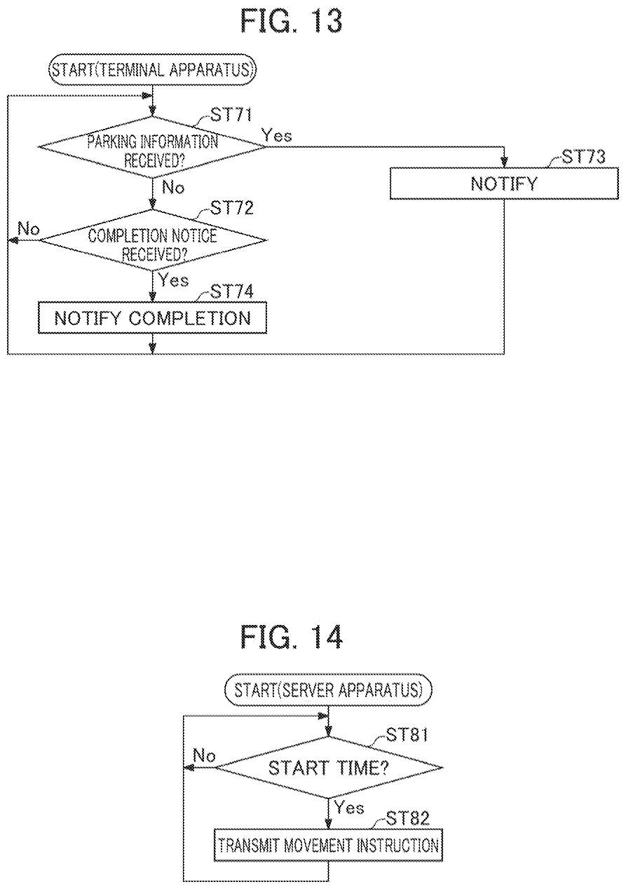

The following describes operation of the parking system 1 according to the present embodiment based on FIGS. 9 to 13. The processes in the operation described below are merely examples, and various processes that can produce the same or similar results may be employed as appropriate. FIG. 9 is a flowchart showing exemplary processes to be performed by the processor 201 of the entry apparatus 200. The processor 201 performs, for example, the processes shown in FIG. 9 based on the programs stored in a storage device such as the ROM 202 or the auxiliary storage device 204. FIGS. 10 and 14 are flowcharts showing exemplary processes to be performed by the processor 101 of the server apparatus 100. The processor 101 performs, for example, the processes shown in FIGS. 10 and 14 based on the programs stored in a storage device such as the ROM 102 or the auxiliary storage device 104. FIG. 11 is a flowchart showing exemplary processes to be performed by the processor 511 of each transport robot 500. The processor 511 performs, for example, the processes shown in FIG. 11 based on the programs stored in a storage device such as the ROM 512 or the auxiliary storage device 514. FIG. 12 is a flowchart showing exemplary processes to be performed by the processor 601 of the filling apparatus 600. The processor 601 performs, for example, the processes shown in FIG. 12 based on the programs stored in a storage device such as the ROM 602 or the auxiliary storage device 604. FIG. 13 is a flowchart showing exemplary processes to be performed by the processor 701 of each terminal apparatus 700. The processor 701 performs, for example, the processes shown in FIG. 13 based on the programs stored in a storage device such as the ROM 702 or the auxiliary storage device 704. The processor 101 of the server apparatus 100 performs, for example, the processes shown in FIG. 10 and the processes shown in FIG. 14 concurrently or in parallel.

The driver of a vehicle 400 who intends to park the vehicle 400 in the parking area AR2 stops the vehicle 400 in the entry area AR1. The driver or another passenger then operates the entry apparatus 200. Alternatively, someone else such as a parking lot attendant may operate the entry apparatus 200. Hereinafter, the vehicle that is parked in the parking area AR2 is referred to as a “target vehicle”. At Step ST11 in FIG. 9, the processor 201 of the entry apparatus 200 determines whether or not to start an entry process for the entry of the target vehicle. For example, the processor 201 determines to start the entry process upon detecting the target vehicle entering the entry area AR1. For another example, the processor 201 determines to start the entry process in response to the driver of the target vehicle or someone else starting the operation of the entry apparatus 200. If the processor 201 determines not to start the entry process, which means No at Step ST11, then the processor 201 repeats the process at Step ST11. If the processor 201 determines to start the entry process, which means Yes at Step ST11, then the processor 201 advances to Step ST12.

At Step ST12, the processor 201 performs a process for obtaining information for identifying the target vehicle (referred to below as “vehicle specific information”) in order to register the target vehicle to be parked with the server apparatus 100. The processor 201 reads, for example, the vehicle specific information from the target vehicle based on information obtained from the sensor 208. The vehicle specific information is, for example, a car registration number or a car license number. The processor 201 reads the vehicle specific information such as the car registration number or the car license number from a car registration plate of the target vehicle using the sensor 208. Alternatively, the vehicle specific information is an on-board identifier (ID) of an on-board instrument of the target vehicle. The on-board ID refers to unique identification information that is assigned to each of manufactured on-board instruments, such as an on-board instrument management number. Alternatively, the vehicle specific information is a card ID of a card such as an electronic toll collection (ETC) card inserted in the on-board instrument of the target vehicle. The card ID refers to unique identification information that is assigned to, for example, each of manufactured ETC cards. The card ID is, for example, an ETC card number. The processor 201 obtains the vehicle specific information such as the on-board ID or the card ID by, for example, communicating with the on-board instrument using the communication interface 205.

At Step ST13, the processor 201 performs a process for obtaining information for identifying the terminal apparatus 700 (referred to below as “terminal specific information”) in order to register the terminal apparatus 700 of a person riding the target vehicle with the server apparatus 100. The processor 201 obtains the terminal specific information from the terminal apparatus 700 using, for example, the communication interface 205 or the sensor 208. The terminal specific information refers to, for example, a unique terminal ID that is assigned to each terminal apparatus 700. The terminal specific information is, for example, a phone number of the terminal apparatus 700. The terminal specific information is, for example, a preregistered user ID. The user ID refers to unique identification information that is assigned to each user of the parking service.

At Step ST14, the processor 201 receives an input of information necessary for the parking of the target vehicle. Such necessary information includes, for example, information indicating whether or not the target vehicle is to be filled with hydrogen and information indicating a clock time at which the target vehicle is going to be moved out of the parking area AR2 (referred to below as “time information”). The operator of the entry apparatus 200 inputs the necessary information using, for example, the input device 206.

At Step ST15, the processor 201 determines whether or not the target vehicle is to be filled with hydrogen based on the input at Step ST14. If the processor 201 determines that the target vehicle is to be filled with hydrogen, which means Yes at Step ST15, then the processor 201 advances to Step ST16.

At Step ST16, the processor 201 obtains, from the target vehicle, the amount of hydrogen remaining in the hydrogen tank and the capacity of the hydrogen tank, or the maximum amount of hydrogen that can be added to the hydrogen tank by, for example, communicating with the target vehicle through the communication interface 205. In a case where the processor 201 obtains the amount of hydrogen remaining in the hydrogen tank and the capacity of the hydrogen tank, the processor 201 calculates the maximum amount of hydrogen that can be added to the hydrogen tank in accordance with the following equation. (Maximum amount of hydrogen that can be added to hydrogen tank)=(Capacity of hydrogen tank)−(Amount of hydrogen remaining in hydrogen tank)

If the processor 201 determines that the target vehicle is not to be filled with hydrogen, which means No at Step ST15, then the processor 201 advances to Step ST17. The processor 201 also advances to Step ST17 after completion of the process at Step ST16.

At Step ST17, the processor 201 generates entry information. The entry information includes the current time, the vehicle specific information, the terminal specific information, filling necessity information, and the time information. The current time included in the entry information indicates a parking start time. The filling necessity information indicates whether or not the vehicle is to be filled with hydrogen. The entry information is based on the input at Step ST14. For example, in a case where an input indicating that the target vehicle is to be filled with hydrogen is received at Step ST14, the filling necessity information indicates that the target vehicle is to be filled with hydrogen. In a case where an input indicating that the target vehicle is to be filled with hydrogen is not received at Step ST14 or an input indicating that the target vehicle is not to be filled with hydrogen is received at Step ST14, the filling necessity information indicates that the target vehicle is not to be filled with hydrogen. The filling necessity information indicating that the target vehicle is to be filled with hydrogen also includes a hydrogen amount. The hydrogen amount is the amount of hydrogen to be added to the hydrogen tank. For example, the hydrogen amount is the maximum amount of hydrogen that can be added to the hydrogen tank. After generating the entry information, the processor 201 instructs the communication interface 205 to transmit the entry information to the server apparatus 100. Upon receiving this transmission instruction, the communication interface 205 transmits the entry information to the server apparatus 100. The transmitted entry information is received by the communication interface 105 of the server apparatus 100. The filling necessity information indicating that the target vehicle is to be filled with hydrogen is an example of what is referred to as first information.

Meanwhile, the processor 101 of the server apparatus 100 determines at Step ST21 in FIG. 10 whether or not the entry information has been received by the communication interface 105. If the processor 101 determines that the entry information has not been received, which means No at Step ST21, then the processor 101 advances to Step ST22.

At Step ST22, the processor 101 determines whether or not exit information has been received by the communication interface 105. If the processor 101 determines that the exit information has not been received, which means No at Step ST22, then the processor 101 advances to Step ST23.

At Step ST23, the processor 101 determines whether or not filling information has been received by the communication interface 105. If the processor 101 determines that the filling information has not been received, which means No at Step ST23, then the processor 101 returns to Step ST21. Thus, the processor 101 stays in a waiting state in which Steps ST21 to ST23 are repeated until the entry information, the exit information, or the filling information has been received. Note that the exit information and the filling information will be described below.

If the processor 101 determines that the entry information has been received while in the waiting state in which Steps ST21 to ST23 are performed, which means Yes at Step ST21, then the processor 101 advances to Step ST24. At Step ST24, the processor 101 generates a parking number to be assigned to the received entry information. The parking number refers to a unique number that is assigned to each parking case. The processor 101 then stores, for example in the parking database, the entry information in association with the parking number.

At Step ST25, the processor 101 determines whether or not the target vehicle is to be filled with hydrogen based on the filling necessity information included in the entry information. If the processor 101 determines that the target vehicle is to be filled with hydrogen, which means Yes at Step ST25, then the processor 201 advances to Step ST26. At Step ST26, the processor. 101 determines a schedule of the hydrogen filling for the target vehicle.

The processor 101 checks the schedule information and determines a start time to start the hydrogen filling for the target vehicle. The start time is a clock time no later than a clock time calculated by subtracting the time required for the hydrogen filling from a clock time indicated by the time information. Alternatively, the start time is a clock time no later than a clock time calculated by subtracting the time required for the hydrogen filling and an additional time allowance from the clock time indicated by the time information. Note that a clock time calculated by adding the time required for the hydrogen filling to the start time is referred to as an end time. The processor 101 calculates, for example, the time required for the hydrogen filling from the hydrogen amount included in the filling necessity information. The higher the hydrogen amount is, the longer the time required for the hydrogen filling is. The processor 101 checks the schedule information and if the filling apparatus 600 is not to be used for a longer period of time than the time required for the hydrogen filling, determines a clock time within this period of time as the start time so that the end time is earlier than the clock time indicated by the time information. If there is no such a period of time, the processor 101 increases a period of time that is earlier than the clock time indicated by the time information and during which the filling apparatus 600 is not to be used, by changing the start time for a vehicle(s) 400 other than the target vehicle. Note that, a new start time for the vehicle(s) 400 other than the target vehicle is determined in the same manner as in the method for determining the start time for the target vehicle.

The processor 101 stores, in the parking database, the start time, the end time, and filling incompletion information in association with the parking number of the target vehicle. The filling incompletion information indicates that the hydrogen filling has not yet finished. If there is a vehicle 400 for which the start time has been changed, the processor 101 rewrites the start time and the end time associated with the parking number of this vehicle 400 to a new start time and a new end time.

The schedule information may be based on clock times at specified time intervals. For example, the start time that is indicated by the schedule information based on clock times at 15-minute intervals is naturally any of the clock times that come every 15 minutes. For example, the minutes value of the start time is chosen from among 0, 15, 30, and 45 minutes.

At Step ST27, the processor 101 generates parking information. The parking information includes the parking number and the end time. After generating the parking information, the processor 101 instructs the communication interface 105 to transmit the parking information to the entry apparatus 200. Upon receiving this transmission instruction, the communication interface 105 transmits the parking information to the entry apparatus 200. The transmitted parking information is received by the communication interface 205 of the entry apparatus 200.

At Step ST28, the processor 101 instructs the communication interface 105 to transmit the parking information to the terminal apparatus 700. Upon receiving this transmission instruction, the communication interface 105 transmits the parking information to the terminal apparatus 700. The transmitted parking information is received by the communication interface 705 of the terminal apparatus 700.

Meanwhile, the processor 201 of the entry apparatus 200 is waiting for the parking information to be received by the communication interface 205 at Step ST18 in FIG. 9. If the processor 201 determines that the parking information has been received, which means Yes at Step ST18, then the processor 201 advances to Step ST19.

At Step ST19, the processor 201 notifies, for example, the operator of the entry apparatus 200 of the parking number and the end time included in the parking information. For example, the processor 201 causes the display of the output device 207 to display the parking number and the end time. For another example, the processor 201 causes the speaker of the output device 207 to output audio indicating the parking number and the end time. The processor 201 returns to Step ST11 after completion of the process at Step ST19.

Meanwhile, the processor 701 of the terminal apparatus 700 determines at Step ST71 in FIG. 13 whether or not the parking information has been received by the communication interface 705. If the processor 701 determines that the parking information has not been received, which means No at Step ST71, then the processor 701 advances to Step ST72.

At Step ST72, the processor 701 determines whether or not a completion notice has been received by the communication interface 705. If the processor 701 determines that the completion notice has not been received, which means No at Step ST72, then the processor 701 returns to Step ST71. Thus, the processor 701 stays in a waiting state in which Steps ST71 and ST72 are repeated until the parking information or the completion notice has been received. The completion notice will be described below.

If the processor 701 determines that the parking information has been received while in the waiting state in which Steps ST71 and ST72 are performed, which means Yes at Step ST71, then the processor 701 advances to Step ST73. At Step ST73, the processor 701 notifies, for example, the operator of the terminal apparatus 700 of the parking number and the end time included in the parking information. For example, the processor 701 causes the display of the output device 707 to display the parking number and the end time. For another example, the processor 701 causes the speaker of the output device 707 to output audio indicating the parking number and the end time. The processor 701 returns to Step ST71 after completion of the process at Step ST73.

Meanwhile, the processor 101 of the server apparatus 100 determines at Step ST29 in FIG. 10 whether or not there is a waiting time before the hydrogen filling for the target vehicle is started. For example, the processor 101 determines that there is a waiting time if the time from the current time to the start time of the hydrogen filling is equal to or longer than a predetermined period of time. The processor 101 then determines that there is no waiting time if the time from the current time to the start time is shorter than the predetermined period of time. If the processor 101 determines that there is no waiting time before the hydrogen filling is started, which means No at Step ST29, then the processor 101 advances to Step ST30.

At Step ST30, the processor 101 generates a first movement instruction. The first movement instruction is information ordering transport of the target vehicle from the entry area AR1 to the filling area AR3. Note that the first movement instruction is an example of what is referred to as a movement instruction. Movement instructions each include, for example, a start position, an end position, and the vehicle specific information of the target vehicle. The start position is information indicating a location from which the transport of the target vehicle is started. The end position is information indicating a location to which the target vehicle is transported. The start position indicated by the first movement instruction is, for example, a location in the entry area AR1 where the target vehicle is stopped. The end position indicated by the first movement instruction is, for example, a location in the filling area AR3 and in front of the filling apparatus 600 where the target vehicle is filled with hydrogen. The processor 101 selects two transport robots 500 that are not in use from among the plurality of transport robots 500. The processor 101 then instructs the communication interface 105 to transmit the first movement instruction to the two transport robots 500. Upon receiving this transmission instruction, the communication interface 105 transmits the first movement instruction to the two transport robots 500. The transmitted first movement instruction is received by the communication interface 515 of each of the two transport robots 500. The processor 101 also instructs the communication interface 105 to transmit the vehicle specific information of the target vehicle to the filling apparatus to which the target vehicle is moved. Upon receiving this transmission instruction, the communication interface 105 transmits the vehicle specific information to the filling apparatus 600. The transmitted vehicle specific information is received by the communication interface 605 of the filling apparatus 600. The processor 101 returns to Step ST21 after completion of the process at Step ST30.

Meanwhile, the processor 511 of each transport robot 500 is waiting for a movement instruction to be received by the communication interface 515 at Step ST51 in FIG. 11. If the processor 511 determines that a movement instruction has been received, which means Yes at Step ST51, then the processor 511 advances to Step ST52. The movement instruction is a generic term used to refer to first to fifth movement instructions. The second to fifth movement instructions will be described below.

At Step ST52, the processors 511 control the components of the two transport robots 500 to transport, based on the received movement instruction, the target vehicle specified by the vehicle specific information included in the received movement instruction from the location indicated by the start position included in the movement instruction to the location indicated by the end position included in the movement instruction. Note that the transport is performed by the two transport robots 500 in cooperation with each other. If the received movement instruction is the first movement instruction, the processors 511 control the components of the two transport robots 500 to lift the target vehicle in the entry area AR1 and transport the target vehicle from the entry area AR1 to the filling area AR3. After completion of the transport, the transport robots 500 are kept on standby under the target vehicle. The processors 511 return to Step ST51 after completion of the process at Step ST52.

If the processor 101 of the server apparatus 100 determines that there is a waiting time before the hydrogen filling is started, which means Yes at Step ST29 in FIG. 10, then the processor 101 advances to Step ST31. If the processor 101 determines that the target vehicle is not to be filled with hydrogen, which means No at Step ST25, then the processor 101 advances to Step ST31. At Step ST31, the processor 101 determines a parking location for the target vehicle. For example, the processor 101 selects one vacant parking space AR21 where no vehicle 400 is parked from among the plurality of parking spaces AR21, and determines the vacant parking space AR21 as the parking location for the target vehicle. The processor 101 also stores, for example in the parking database, a space ID of the determined parking location in association with the parking number of the target vehicle. The space ID refers to unique identification information that is assigned to each parking space.

At Step ST32, the processor 101 generates a second movement instruction. The second movement instruction is information ordering transport of the target vehicle from the entry area AR1 to the parking area AR2. The start position indicated by the second movement instruction is, for example, the location in the entry area AR1 where the target vehicle is stopped. The end position indicated by the second movement instruction is, for example, the location of the parking space AR21 determined at Step ST31. The processor 101 selects two transport robots 500 that are not in use from among the plurality of transport robots 500. The processor 101 then instructs the communication interface 105 to transmit the second movement instruction to the two transport robots 500. Upon receiving this transmission instruction, the communication interface 105 transmits the second movement instruction to the two transport robots 500. The transmitted second movement instruction is received by the communication interface 515 of each of the two transport robots 500. The processor 101 returns to Step ST21 after completion of the process at Step ST32.

The transport robots 500 that have received the second movement instruction lift the target vehicle in the entry area AR1 and transport the target vehicle from the entry area AR1 to the parking area AR2. After completion of the transport, the transport robots 500 get out from under the target vehicle and move to, for example, a standby location where the transport robots 500 that are not in use are kept on standby.

Meanwhile, the processor 601 of the filling apparatus 600 is waiting for the vehicle specific information to be received by the communication interface 605 at Step ST61 in FIG. 12. This vehicle specific information is the vehicle specific information of a vehicle 400 to be filled with hydrogen next by the filling apparatus 600. If the processor 601 determines that the vehicle specific information has been received, which means Yes at Step ST61, then the processor 601 advances to Step ST62.

At Step ST62, the processor 601 performs a process for filling the hydrogen tank of the target vehicle with hydrogen. For example, an operator of the filling apparatus 600 connects a hose for the hydrogen filling to the target vehicle. The operator then presses a filling start button, which is a button for starting the hydrogen filling. In response, the processor 601 controls the filling unit 606 to start filling the target vehicle with hydrogen. The processor 601 then finishes the hydrogen filling when the hydrogen tank of the target vehicle is full or a filling stop button, which is a button for stopping the hydrogen filling, is pressed by, for example, the operator. The processor 601 and the filling unit 606 measure the amount of hydrogen that has been fed to the target vehicle (referred to below as a “filling amount”) in corporation with each other. Upon completion of the hydrogen filling, the processor 601 advances to Step ST63.

At Step ST63, the processor 601 generates filling information. The filling information includes, for example, the filling amount measured at Step ST62 and the vehicle specific information received at Step ST61. After generating the filling information, the processor 601 instructs the communication interface 605 to transmit the filling information to the server apparatus 100. Upon receiving this transmission instruction, the communication interface 605 transmits the filling information to the server apparatus 100. The transmitted filling information is received by the communication interface 105 of the server apparatus 100. The processor 601 returns to Step ST61 after completion of the process at Step ST63.

If the processor 101 determines that the filling information has been received while in the waiting state in which Steps ST21 to ST23 are performed, which means Yes at Step ST23, then the processor 101 advances to Step ST33. At Step ST33, the processor 101 calculates the fee for the hydrogen filling (referred to below as the “filling fee”) from the filling amount included in the filling information.

At Step ST34, the processor 101 stores, in the parking database, the filling fee in association with the parking number of the target vehicle. The processor 101 also rewrites the filling incompletion information associated with the parking number to filling completion information. The filling completion information indicates that the hydrogen filling has finished.

At Step ST35, the processor 101 generates a completion notice. The completion notice is information notifying that the hydrogen filling has finished. After generating the completion notice, the processor 101 instructs the communication interface 105 to transmit the completion notice to the terminal apparatus 700. Upon receiving this transmission instruction, the communication interface 105 transmits the completion notice to the terminal apparatus 700. The transmitted completion notice is received by the communication interface 705 of the terminal apparatus 700. The completion notice is an example of what is referred to as second information. The processor 101 also functions, in cooperation with the communication interface 705, as an example of what is referred to as a transmission unit through performing the process at Step ST35.

If the processor 701 of the terminal apparatus 700 determines that the completion notice has been received while in the waiting state in which Steps ST71 and ST72 in FIG. 13 are performed, which means Yes at Step ST72, then the processor 701 advances to Step ST74. At Step ST74, the processor 701 notifies, for example, the operator of the terminal apparatus 700 that the hydrogen filling has finished. For example, the processor 701 causes the display of the output device 707 to display an image indicating that the hydrogen filling has finished. For another example, the processor 701 causes the speaker of the output device 707 to output audio indicating that the hydrogen filling has finished. The processor 701 returns to Step ST71 after completion of the process at Step ST74.

Meanwhile, the processor 101 of the server apparatus 100 determines a parking location for the target vehicle at Step ST36 in FIG. 10. For example, the processor 101 selects one vacant parking space AR21 where no vehicle 400 is parked from among the plurality of parking spaces AR21, and determines the vacant parking space AR21 as the parking location for the target vehicle. The processor 101 also stores, for example in the parking database, the space ID of the determined parking location in association with the parking number of the target vehicle. If the parking number has already been associated with a space ID, the processor 101 overwrites the existing space ID.

At Step ST337, the processor 101 generates a third movement instruction. The third movement instruction is information ordering transport of the target vehicle from the filling area AR3 to the parking area AR2. The start position indicated by the third movement instruction is, for example, the filling area AR3. The end position indicated by the third movement instruction is, for example, the location of the parking space AR21 determined at Step ST36. The processor 101 instructs the communication interface 105 to transmit the third movement instruction to the two transport robots 500 lifting the target vehicle under the target vehicle. Upon receiving this transmission instruction, the communication interface 105 transmits the third movement instruction to the two transport robots 500. The transmitted third movement instruction is received by the communication interface 515 of each of the two transport robots 500. The processor 101 returns to Step ST21 after completion of the process at Step ST37.

The transport robots 500 that have received the third movement instruction transport the target vehicle from the filling area AR3 to the parking area AR2. After completion of the transport, the transport robots 500 get out from under the target vehicle and move to, for example, the standby location where the transport robots 500 that are not in use are kept on standby.

In a case where the parking number of the target vehicle is associated with the filling incompletion information, the processor 101 of the server apparatus 100 waits at Step ST81 in FIG. 14 for the start time for the target vehicle or a clock time a predetermined period of time earlier than the start time to come. If the processor 101 determines that the start time or the clock time the predetermined period of time earlier than the start time has come, which means Yes at Step ST81, then the processor 101 advances to Step ST82. Note that this process is performed not only for the parking number of the target vehicle but also for all other parking numbers associated with filling incompletion information. That is, the processor 101 also waits for the start time associated with each of such parking numbers or a clock time the predetermined period of time earlier than the start time to come. The following describes an example in which this process is performed for the target vehicle.

At Step ST82, the processor 101 generates a fourth movement instruction. The fourth movement instruction is information ordering transport of the target vehicle from the parking area AR2 to the filling area AR3. The start position indicated by the fourth movement instruction is, for example, the location in the parking space AR21 where the target vehicle is parked. The end position indicated by the fourth movement instruction is, for example, a location in the filling area AR3 and in front of the filling apparatus 600 where the target vehicle is filled with hydrogen. The processor 101 selects two transport robots 500 that are not in use from among the plurality of transport robots 500. The processor 101 then instructs the communication interface 105 to transmit the fourth movement instruction to the two transport robots 500. Upon receiving this transmission instruction, the communication interface 105 transmits the fourth movement instruction to the two transport robots 500. The transmitted fourth movement instruction is received by the communication interface 515 of each of the two transport robots 500. The processor 101 also instructs the communication interface 105 to transmit the vehicle specific information of the target vehicle to the filling apparatus to which the target vehicle is moved. Upon receiving this transmission instruction, the communication interface 105 transmits the vehicle specific information to the filling apparatus 600. The transmitted vehicle specific information is received by the communication interface 605 of the filling apparatus 600. The processor 101 returns to Step ST81 after completion of the process at Step ST62.

The transport robots 500 that have received the fourth movement instruction lift the target vehicle in the parking area AR2 and transport the target vehicle from the parking area AR2 to the filling area AR3. After completion of the transport, the transport robots 500 are kept on standby under the target vehicle. The filling apparatus 600 performs the processes in FIG. 12 as in the foregoing case.

The driver of the target vehicle, for example, who intends to move the target vehicle out of the parking area AR2 operates the exit apparatus 300 in the exit area AR4 to give an exit instruction for the target vehicle to the exit apparatus 300. The driver also inputs the vehicle specific information or the parking number to the exit apparatus 300 as information for identifying the target vehicle. Note that a parking lot attendant may operate the exit apparatus 300.

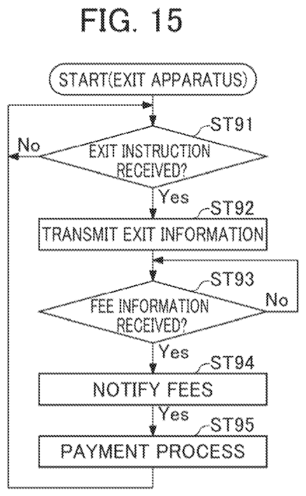

The processor 301 of the exit apparatus 300 is waiting for an input of the exit instruction at Step ST91 in FIG. 15. If the processor 301 determines that the input of the exit instruction has been received, which means Yes at Step ST91, then the processor 301 advances to Step ST92.

At Step ST92, the processor 301 generates exit information. The exit information indicates the exit instruction for the vehicle 400. The exit information includes, for example, the parking number or the vehicle specific information inputted to the exit apparatus 300. After generating the exit information, the processor 301 instructs the communication interface 305 to transmit the exit information to the server apparatus 100. Upon receiving this transmission instruction, the communication interface 305 transmits the exit information to the server apparatus 100. The transmitted exit information is received by the communication interface 105 of the server apparatus 100.

If the processor 101 of the server apparatus 100 determines that the exit information has been received while in the waiting state in which Steps ST21 to ST23 in FIG. 10 are performed, which means Yes at Step ST22, then the processor 101 advances to Step ST38. At Step ST38, the processor 101 refers to the parking database to obtain various information associated with the parking number included in the exit information. Alternatively, the processor 101 refers to the parking database to obtain various information associated with the parking number associated with the vehicle specific information included in the exit information.

At Step ST39, the processor 101 generates a fifth movement instruction. The fifth movement instruction is information ordering transport of the target vehicle from the parking area AR2 to the exit area AR4. The start position indicated by the fifth movement instruction is, for example, the location of the parking space AR21 where the target vehicle is parked. The end position indicated by the fifth movement instruction is, for example, the exit area AR4. The processor 101 selects two transport robots 500 that are not in use from among the plurality of transport robots 500. The processor 101 then instructs the communication interface 105 to transmit the fifth movement instruction to the two transport robots 500. Upon receiving this transmission instruction, the communication interface 105 transmits the fifth movement instruction to the two transport robots 500. The transmitted fifth movement instruction is received by the communication interface 515 of each of the two transport robots 500.

The transport robots 500 that have received the fifth movement instruction lift the target vehicle in the parking area AR2 and transport the target vehicle from the parking area AR2 to the exit area AR4. After completion of the transport, the transport robots 500 get out from under the target vehicle and move to, for example, the standby location where the transport robots 500 that are not in use are kept on standby.

At Step ST40, the processor 101 determines a parking fee for the target vehicle based on the information obtained at Step ST38. For example, the processor 101 determines the parking fee based on the time from the parking start time to the current time. The processor 101 also calculates a total fee by combining the parking fee and the filling fee. For example, the processor 101 calculates the total fee by simply adding up the parking fee and the filling fee. Alternatively, the processor 101 may calculate the total fee by adding or subtracting a predetermined amount of money to or from the sum calculated by adding up the parking fee and the filling fee. Note that the filling fee is 0 yen in a case where the process at Step ST34 has not been performed for the target vehicle.

At Step ST41, the processor 101 generates fee information. The fee information includes, for example, the parking fee, the filling fee, and the total fee. After generating the fee information, the processor 101 instructs the communication interface 105 to transmit the fee information to the exit apparatus 300. Upon receiving this transmission instruction, the communication interface 105 transmits the fee information to the exit apparatus 300. The transmitted fee information is received by the communication interface 305 of the exit apparatus 300. The processor 101 returns to Step ST21 after completion of the process at Step ST41.

Meanwhile, the processor 301 of the exit apparatus 300 is waiting for the fee information to be received by the communication interface 305 at Step ST93 in FIG. 15. If the processor 301 determines that the fee information has been received, which means Yes at Step ST93, then the processor 301 advances to Step ST94.

At Step ST94, the processor 301 notifies, for example, the operator of the exit apparatus 300 of the parking fee, the filling fee, and the total fee included in the fee information. For example, the processor 301 causes the display of the output device 307 to display the parking fee, the filling fee, and the total fee. For another example, the processor 301 causes the speaker of the output device 307 to output audio indicating the parking fee, the filling fee, and the total fee.

At Step ST95, the processor 301, in corporation with the server apparatus 100, performs a process for a payment of the total fee using the payment device 308. Examples of payment means usable for the payment include cash, a credit card, and electronic money. A known method may be employed in the process for the payment, and description thereof will be omitted. The processor 301 returns to Step ST91 after completion of the process at Step ST95.

The parking system 1 according to the foregoing embodiment transports a vehicle 400 to the filling area AR3. The parking system 1 according to the foregoing embodiment then transports the vehicle 400 from the filling area AR3 to the parking area AR2. By transporting the vehicle 400 from the filling area AR3 to the parking area AR2, the parking system 1 according to the foregoing embodiment can free up space for the hydrogen filling for another vehicle 400.

The parking system 1 according to the foregoing embodiment transports a vehicle 400 from the parking area AR2 to the filling area AR3. Thus, the parking system 1 according to the foregoing embodiment can allow a vehicle 400 having a waiting time before the hydrogen filling has started to stay in the parking area AR2.

The parking system 1 according to the foregoing embodiment transports the vehicle 400 that has finished the hydrogen filling from the filling area AR3 to the parking area AR2. By transporting the vehicle 400 that has finished the hydrogen filling from the filling area AR3 to the parking area AR2, the parking system 1 according to the foregoing embodiment can free up space for the hydrogen filling for another vehicle 400.

The parking system 1 according to the foregoing embodiment creates schedules of the hydrogen filling for a plurality of vehicles 400. Thus, the parking system 1 according to the foregoing embodiment can efficiently use the filling apparatus 600.

In the parking system 1 according to the foregoing embodiment, a notice is transmitted to the terminal apparatus 700 in a case in which the hydrogen filling has finished. Thus, the operator of the terminal apparatus 700 can know that the hydrogen filling has finished.

The parking system 1 according to the foregoing embodiment determines the parking fee and the filling fee. Thus, the parking system 1 according to the foregoing embodiment can allow a payment in the amount of these fees.

The foregoing embodiment may be modified as follows. The server apparatus 100 may receive an advance reservation for the hydrogen filling. The operator of the terminal apparatus 700 inputs, for example by operating the terminal apparatus 700, the vehicle specific information of the vehicle 400 to be filled with hydrogen and a clock time at which the vehicle 400 is going to be moved out of the parking area AR2. Based on this input, the processor 101 of the server apparatus 100 performs the same process as the process at Step ST26, and thus determines a schedule of the hydrogen filling for the vehicle 400 in accordance with the inputted vehicle specific information and the inputted clock time. The processor 101 also generates a parking number and stores, in the parking database, the parking number and other relevant information as in the process at Step ST24. When the vehicle 400 is actually parked, the processor 101 uses the parking number to perform various processes. Enabling such an advance reservation improves the convenience for users of the parking service. Enabling such an advance reservation also allows the server apparatus 100 to determine the schedule of the hydrogen filling before the vehicle 400 is parked.

The processor 101 cancels the reservation if the vehicle 400 having the advance reservation received by the server apparatus 100 is not in the parking area AR2 at the start time of the hydrogen filling or a clock time the predetermined period of time earlier than the start time. That is, the processor 101 deletes the information related to the vehicle 400 from the schedule information. The processor 101 also deletes all information associated with the parking number of the vehicle 400. Thus, a time is made available for the parking system 1 to perform the hydrogen filling for another vehicle 400.

The server apparatus 100 may transmit, upon changing the start time of the hydrogen filling for a vehicle 400, information for communicating the time change to the terminal apparatus 700 identified by the terminal specific information associated with the parking number associated with the vehicle specific information of the vehicle 400. In this case, the terminal apparatus 700 notifies the operator of the terminal apparatus 700 of the time change.

Through performing the processes in FIGS. 10 and 14 described above, the processor 101 functions as an example of what is referred to as a processing unit.

In the foregoing embodiment, the entry apparatus 200 transmits the entry information. Alternatively, the terminal apparatus 700 may transmit the entry information. In this case, the operator of the terminal apparatus 700 operates the terminal apparatus 700 to issue an entry instruction for the target vehicle.

In the foregoing embodiment, the exit apparatus 300 transmits the exit information. Alternatively, the terminal apparatus 700 may transmit the exit information. In this case, the operator of the terminal apparatus 700 operates the terminal apparatus 700 to issue an exit instruction for the target vehicle.

In the foregoing embodiment, the processor 101, the processor 201, the processor 301, the processors 511, the processor 601, and the processor 701 implement the processes through the programs. However, at least one of the processors may implement some or all of the processes through a hardware configuration of a circuit.

The programs for implementing the processes according to the foregoing embodiment are transferred, for example, after being stored in the apparatuses. However, the apparatuses may be transferred without the programs stored therein. In this case, the programs may be transferred separately from the apparatuses and later written to the apparatuses. The programs can be transferred, for example, by being recorded on a removable storage medium or by being downloaded via a network such as the Internet or a LAN. Such a removable storage medium is an example of what is referred to as a non-transitory computer readable medium.

Embodiments of the present invention have been described above. However, the embodiments are merely examples and should not be construed to be limiting the scope of the present invention. The embodiments of the present invention may be implemented in various different forms that do not deviate from the gist of the present invention.

### EXPLANATION OF REFERENCE NUMERALS

1: Parking system
100: Server apparatus
101, 201, 301, 511, 601, 701: Processor
102, 202, 302, 512, 602, 702: ROM
103, 203, 303, 513, 603, 703: RAM
104, 204, 304, 514, 604, 704: Auxiliary storage device
105, 205, 305, 515, 605, 705: Communication interface
106, 209, 309, 516, 607, 708: Bus
200: Entry apparatus
206, 306, 706: Input device
207, 307, 707: Output device
208, 550: Sensor
300: Exit apparatus
308: Payment device
400: Vehicle
500: Transport robot
510: Control unit
520: Motor
530: Wheel
541, 542: Arm
600: Filling apparatus
606: Filling unit
700: Terminal apparatus

What is claimed is:

1. A transport system comprising:
a server apparatus; and
a transport apparatus configured to transport a vehicle having a hydrogen tank based on an instruction given by the server apparatus,
the server apparatus including a processing unit configured to
receive an input of first information indicating that the vehicle needs to be filled with hydrogen, and
in a case in which the input of the first information has been received, instruct the transport apparatus to transport the vehicle to a filling area for hydrogen filling and instruct the transport apparatus to transport the vehicle from the filling area to a parking area for vehicle parking.

2. The transport system according to claim 1, wherein the processing unit instructs the transport apparatus to transport the vehicle to the parking area, and instructs the transport apparatus to transport the vehicle from the parking area to the filling area in a case in which the vehicle is to be filled with hydrogen.

3. The transport system according to claim 1, wherein the processing unit instructs the transport apparatus to transport the vehicle from the filling area to the parking area upon completion of the hydrogen filling with respect to the hydrogen tank of the vehicle.

4. The transport system according to claim 1, wherein the processing unit creates a schedule indicating a scheduled clock time of the hydrogen filling for the vehicle and instructs the transport apparatus to transport the vehicle to the filling area based on the schedule.

5. The transport system according to claim 4, wherein the processing unit
receives a reservation for the hydrogen filling for the vehicle and
includes a scheduled clock time based on the reservation in the schedule.

6. The transport system according to claim 5, wherein the processing unit cancels the reservation if the vehicle having the reservation is not in the parking area at a predetermined time based on the schedule.

7. The transport system according to claim 1, wherein the server apparatus further includes a transmission unit configured to transmit, in a case in which the hydrogen filling with respect to the hydrogen tank of the vehicle has finished, second information to a terminal apparatus of a person who rides the vehicle, the second information indicating that the hydrogen filling has finished.

8. The transport system according to claim 1, wherein the processing unit determines a parking fee and a hydrogen filling fee.

9. A server apparatus comprising a processing unit configured to
receive an input of first information indicating that a vehicle having a hydrogen tank needs to be filled with hydrogen, and
in a case in which the input of the first information has been received, instruct a transport apparatus for transporting the vehicle to transport the vehicle to a filling area for hydrogen filling and instruct the transport apparatus to transport the vehicle from the filling area to a parking area for vehicle parking.

10. A non-transitory computer readable medium storing therein a program for causing a processor in a server apparatus to function as a processing unit configured to
receive an input of first information indicating that a vehicle having a hydrogen tank needs to be filled with hydrogen, and
in a case in which the input of the first information has been received, instruct a transport apparatus for transporting the vehicle to transport the vehicle to a filling area for hydrogen filling and instruct the transport apparatus to transport the vehicle from the filling area to a parking area for vehicle parking.
